(19) United States
(12) Patent Application Publication
(10) Pub. No.: US 2007/0218214 A1
(43) Pub. Date: Sep. 20, 2007

(54) METHOD OF IMPROVING ADHESION PROPERTY OF DIELECTRIC LAYER AND INTERCONNECT PROCESS

(76) Inventors: Kuo-Chih Lai, Tainan City (TW); Mei-Ling Chen, Kaohsiung City (TW); Jei-Ming Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,240

(22) Filed: Mar. 14, 2006

(51) Int. Cl. H05H 1/00

(52) U.S. Cl. 427/535

(57) ABSTRACT

A method of improving adhesion property of a dielectric layer is provided. A dielectric layer is formed over a substrate. A plasma surface process comprising a plasma gas containing helium or hydrogen is performed to treat the surface of the dielectric layer. A cap layer is formed on the dielectric layer.

### BACKGROUND OF THE INVENTION

1. Field of Invention

The present invention relates to a method of improving surface property of a dielectric layer and a semiconductor process. More particularly, the present invention relates to a method of improving the adhesion property of a dielectric layer and a method of fabricating interconnect.

2. Description of Related Art

As density of the interconnect wires increases continuously along with the increase of the integration of the device, problems due to RC delay of the devices becomes more and more serious, and the operation speed of the devices is accordingly reduced. Therefore, in the fabrication deep sub-micron level semiconductor devices, low dielectric constant material is usually used as the insulation layer to reduce the problems due to RC delay. For example, the low dielectric material is used as the insulation layer between the conductive wires in order to reduce the parasitic capacitance between the conductive wires and thereby reduce the problems due to of RC delay. Thus, the operating speed of device is effectively promoted.

However, low dielectric constant material can not endure high temperature, and the low dielectric constant material has poor thermal stability and high coefficient of thermal expansion. Therefore, in the fabrication processes using low dielectric constant material may cause some reliability problems. In particular, in the process of multiple interconnect wires, a chemical mechanical polishing (CMP) process is usually performed to planarize the surface of the insulation layer. Accordingly, a better adhesion property of the low dielectric constant material may reduce the possibility of peeling or delamination of the low dielectric constant material from the substrate or film layer adhered thereto, and thereby improve the yield rate and the reliability of the semiconductor device.

U.S. Pat. No. 6,821,571 B2 discloses a plasma process for treating carbon containing material using plasma gas containing argon (Ar) and other inert gases to improve the adhesion property of the carbon containing material. As the molecular weight of Ar is high, the Ar plasma gas may damage the surface of the carbon containing material and may affect subsequent fabricating processes and also adversely affect the reliability of the device.

U.S. Pat. No. 6,867,126 B1 discloses a plasma process for treating low dielectric constant material using plasma gas containing CO₂, He and NH₃ to improve the cracking threshold the low dielectric constant material. However, CO₂ plasma gas may adversely affect the dielectric constant of the low dielectric constant material, and the surface of the conductive layer, such as copper, may be easily oxidized when exposed to NH₃ plasma gas. Furthermore, the power used during the plasma process is about 2000 watt, which is too high and may adversely affect the electrical properties of the low dielectric constant material.

### SUMMARY OF THE INVENTION

Accordingly, the present invention is directed to a method of improving adhesion property of a dielectric layer so that the aforementioned defects may be effectively reduced and thereby effectively promote the fabrication yield the reliability of the semiconductor device.

Another aspect of the present invention is to provide an interconnect process, the present invention is capable of reducing defects or problems resulting from poor adhesion property of the dielectric layer.

According to an embodiment of the present invention, a dielectric layer is formed over the substrate. Next, the surface of the dielectric layer is treated with a plasma gas containing, for example, He or H₂. Next, a cap layer is formed over the dielectric layer.

According to the embodiment of the present invention, the material of the dielectric layer is comprised of, for example, a low dielectric constant material or a porous dielectric material, and the dielectric constant of the dielectric layer is less than 3.5. The dielectric layer may be formed using known methods, for example, a plasma enhanced chemical vapor deposition method or a spin on coating method.

According to an embodiment of the present invention, the flow rate of the plasma gas is between 100 SCCM and 100,000 SCCM. The pressure of the plasma process is between 2.5 torr and 20 torr, and the temperature is between 200° C. and 450° C. The plasma source may comprise, for example, a single frequency radio frequency or a dual frequency radio frequency, and the plasma power is between 100 watt and 300 watt.

According to the embodiment of the present invention, the material of the cap layer comprises, for example, SiN, SiCN, SiCO, or SiNO, and the cap layer may be formed using, for example, a chemical vapor deposition method.

According to an embodiment of the present invention, the plasma process may be performed by the in-situ method or the ex-situ method.

The present invention also provides a method of fabricating interconnect structure. First, a dielectric layer is formed over the substrate. Next, an opening is formed in the dielectric layer. Next, a conductive layer is formed over the dielectric layer, wherein the conductive layer fills the opening. Next, a top portion of the conductive layer is removed until the dielectric layer is exposed. Next, the dielectric layer is treated with a plasma gas containing, for example, helium or hydrogen. Next, a cap layer is formed over the dielectric layer and the conductive layer.

According to an embodiment of the present invention, the material of the dielectric layer may be comprised of, for example, a low dielectric constant material or porous dielectric material, and the dielectric constant of the dielectric layer is less than 3.5. The dielectric layer may be formed using well known methods, for example, a plasma enhanced chemical vapor deposition or a spin on coating method.

According to an embodiment of the present invention, the method of forming the opening in the dielectric layer includes, for example, forming a patterned photoresist layer over the dielectric layer; and etching the dielectric layer using the patterned photoresist layer as an etching mask to remove a portion of the dielectric layer to form the opening.

According to an embodiment of the present invention, the method of removing a portion of the conductive layer until the dielectric layer is exposed includes, for example, a chemical mechanical polishing (CMP) method.

According to an embodiment of the present invention, the material of the conductive layer comprises Cu, Al, W, or alloys thereof.

According to an embodiment of the present invention, the process condition of the plasma process includes, for example, the flow rate of the plasma gas is between 100 SCCM and 100,000 SCCM, the pressure is between 2.5 torr and 20 torr, the temperature is between 200° C. and 450° C., the plasma source comprises, for example, a single frequency radio frequency or a dual frequency radio frequency, and the power is between 100 watt and 300 watt.

According to an embodiment of the present invention, the material of the cap layer comprises, for example, SiN, SiCN, SiCO, or SiNO, and the cap layer may be formed by using, for example, a chemical vapor deposition method.

According to an embodiment of the present invention, the plasma process may be performed by the in-situ method, or the ex-situ method.

The surface of the dielectric layer is treated with a plasma gas to improve the surface adhesion property of the dielectric layer so that problems, such as peeling or delamination, of the dielectric layer during the fabrication process may be effectively reduced. Thus, the yield rate and reliability of the semiconductor device can be effectively improved. The plasma gas includes He or H₂ so that the electrical properties of the dielectric layer and the conductive layer will not be substantially affected and also the subsequent fabrication processes will not be affected. In addition, the plasma process may also remove any contaminants or residues adhering to the surface of the conductive layer and the dielectric layer after the CMP method.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A-1C are schematic cross-sectional views illustrating the process steps of a method of improving adhesion property of the dielectric layer according to an embodiment of the present invention.

FIG. 2A-2E are schematic cross-sectional diagrams illustrating the process steps of a method of fabricating an interconnect structure according to an embodiment of the present invention.

FIG. 3 is a comparison graph comparing the adhesion property of the dielectric layer treated according to the present invention with that of the conventional dielectric layer.

### DESCRIPTION OF EMBODIMENTS

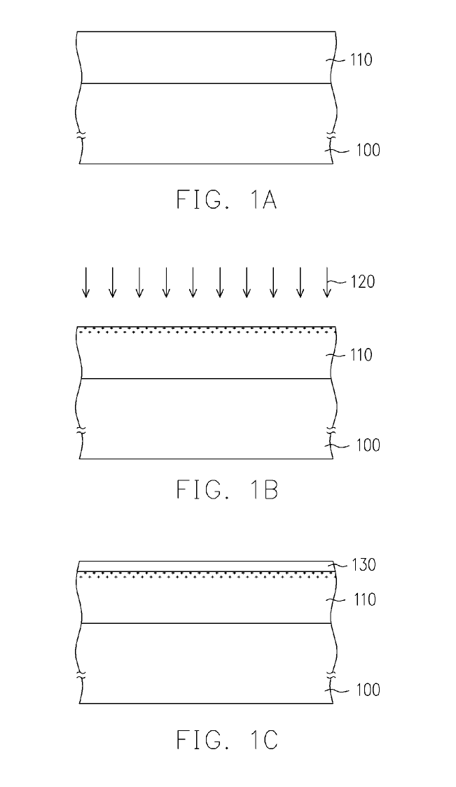

FIG. 1A-1C are schematic cross-sectional views illustrating the process steps of a method of improving the adhesion property of the dielectric layer according to an embodiment of the present invention.

First, referring to FIG. 1A, a dielectric layer 110 is formed over the substrate 100. The dielectric layer 110 comprises, for example, a low dielectric constant material or a porous dielectric material having a dielectric constant, for example, less than 3.5. The dielectric layer 110 is formed using, for example, a plasma enhanced chemical vapor deposition (PECVD) method or spin on coating method.

Next, referring to FIG. 1B, a plasma process 120 is performed, wherein the surface of the dielectric layer 110 is treated with a plasma gas containing, for example, helium or hydrogen. The process condition of the plasma process includes a gas flow rate between 100 SCCM and 100,000 SCCM, a pressure between 2.5 torr and 20 torr and a temperature between 200° C. and 450° C. The plasma source includes, for example, a single frequency radio frequency or a dual frequency radio frequency, and the plasma power between 100 watt and 300 watt. When the surface of the dielectric layer 110 is treated with the plasma gas mentioned above during the plasma process 120, the characteristics of the surface of the dielectric layer 110 is modified so as to increase the adhesion property of the surface of the dielectric layer 110.

It should be noted that because the plasma process of the present invention includes a plasma gas containing helium or hydrogen is used, and therefore defects on the surface of the dielectric layer resulting from exposure to plasma gas containing Ar or CO₂ can be effectively avoided. In addition, the plasma power of the plasma process of the present invention is substantially low, and therefore damage to the electrical properties of the low dielectric constant material may be minimal.

Next, referring to FIG. 1C, a cap layer 130 is formed over the dielectric layer 110. The cap layer 130 may comprise, for example, SiN, SiCN, SiCO, or SiNO. The cap layer 130 may be formed using, for example, a chemical vapor deposition method or any other suitable methods. As the adhesion property of the surface of the dielectric layer 110 is increased after being treated by the plasma process 120, and therefore the adhesion of the cap layer 130 to the dielectric layer 110 is sufficient to resist the problems such as peeling or delamination of the cap layer 130 from the dielectric layer 110.

In an embodiment of the present invention, the plasma process 120 may be performed in-situ, that is, formation of the dielectric layer 110 and the cap layer 130, and the plasma process 120 are carried out and completed within the same reaction chamber. According to another embodiment of the present invention, the plasma process 120 may be performed in ex-situ.

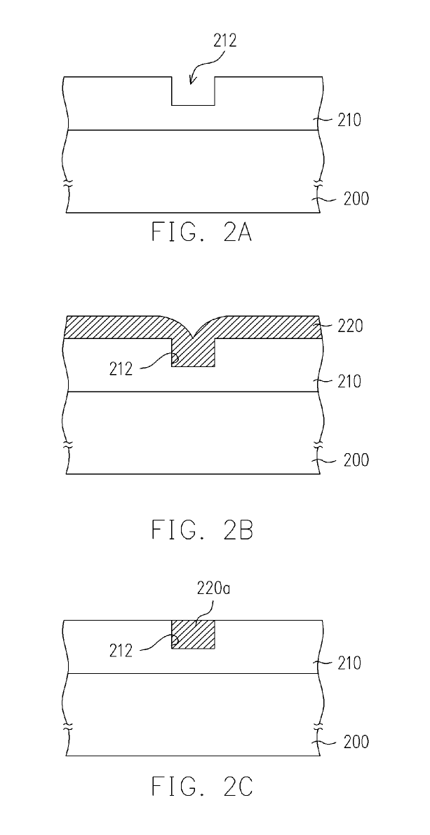

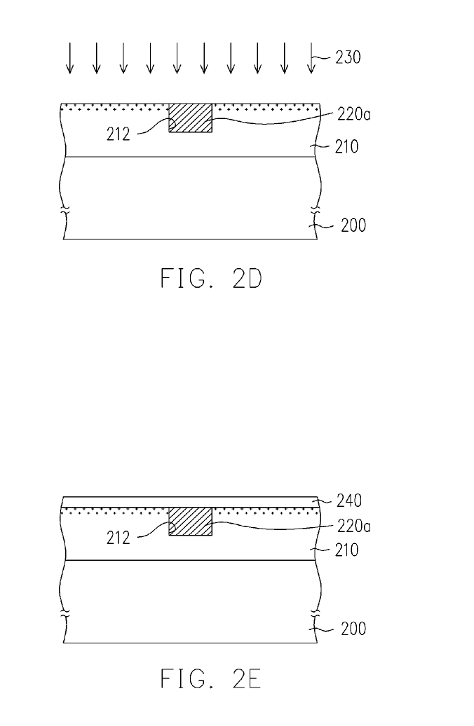

The following will further describe the application of the method of increasing the adhesion property of the dielectric layer in the fabrication of an interconnect structure. FIG. 2A-2E are schematic cross-sectional views illustrating the process steps of a method of fabricating an interconnect structure according to an embodiment of the present invention.

First, referring to FIG. 2A, a dielectric layer 210 is formed over the substrate 200. The dielectric layer 210 may be comprised of, for example, a low dielectric constant material or a porous dielectric material having a dielectric constant, for example, less than 3.5. The dielectric layer 210 may be formed by using, for example, a PECVD method or a spin on coating method. Next, an opening 212 is formed in the dielectric layer 210. Wherein, the process of forming the opening 212 in the dielectric layer 210 includes, for example, forming a photoresist layer (not shown) over the dielectric layer 210; and etching the dielectric layer 210 to a portion of the dielectric layer 210 using the patterned photoresist layer as the etching mask to form the opening 212. Of course, the opening 212 can also be formed by other suitable methods. The opening 212 may be, for example, a damascene opening, a contact window opening or trench.

Next, referring to FIG. 2B, a conductive layer 220 is formed over the dielectric layer 210, wherein the conductive layer 220 fills the opening 212. The material of the conductive layer 220 comprises, for example, Cu, Al, W or alloys thereof.

Next, referring to FIG. 2C, a portion of the conductive layer 220 is removed to expose a portion of the dielectric layer 210 to form patterned conductive layer 220a. The process of removing a portion of the conductive layer 220 may include, for example, a chemical mechanical polishing method. In general, the slurry used in the chemical mechanical polishing process contains benzotriazole (BTA) and residues of BTA may remain on the surfaces of the conductive layer 220a and the dielectric layer 210 after the CMP process, which may adversely affect the subsequent fabrication processes.

Next, referring to FIG. 2D, a plasma process 230 using plasma gas containing, for example, helium or hydrogen to treat the surface of the dielectric layer 210. The process conditions of the plasma process includes a flow rate of the plasma gas between 100 SCCM and 100,000 SCCM, a pressure between 2.5 torr and 20 torr, a temperature between 200° C. and 450° C., a plasma source including, for example, a single frequency radio frequency or a dual frequency radio frequency and power between 100 watt and 300 watt.

As mentioned above, the function of the plasma surface process 230 is to change the property of the surface of the dielectric layer 210 so as to increase the adhesion property of the dielectric layer 210, moreover, the residual remained on the surfaces of the patterned conductive layer 220a and the dielectric layer 210 after the chemical mechanic abrasion can be removed to avoid the effect for the successive fabricating processes.

It should be noted that, as because the plasma process of the present invention includes a plasma gas containing helium or hydrogen, and therefore defects on the surface of the dielectric layer and the patterned conductive layer 220a resulting from exposure to plasma gas containing Ar or NH3 can be effectively avoided.

Next, referring to FIG. 2E, a cap layer 240 is formed over the dielectric layer 210 and the conductive layer 220a, wherein the cap layer 240 may be used for protecting the surface of the patterned conductive layer 220a. The material of the cap layer 240 may comprise, for example, SiN, SiCN, SiCO, or SiNO. The cap layer 240 may be formed using, for example, a chemical vapor deposition method. The adhesion property of the surface of the dielectric layer 210 is substantially improved by treating the surface with a plasma gas containing helium or hydrogen so that the problems such as peeling or delamination of the cap layer 240 adhered to the dielectric layer 120 may be effectively avoided. Thus, the reliability of the semiconductor device is substantially promoted

In one embodiment, the plasma process 230 may be performed in-situ. In another embodiment, the plasma process 230 may be performed in ex-situ.

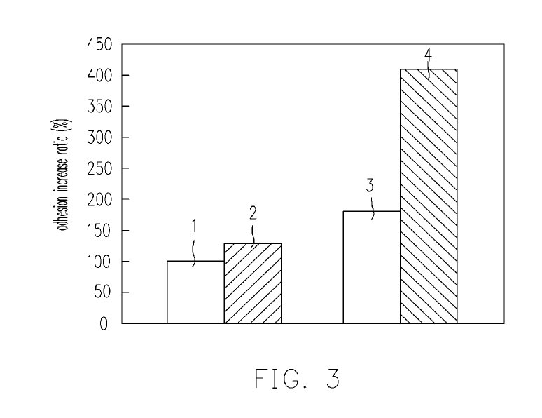

FIG. 3 is a comparison graph comparing the adhesion property of the dielectric layer processed by plasma process with that of the dielectric layer not processed by the plasma process. Wherein, the percentage improvement in adhesion property of the porous dielectric layer indicated by bar graph 1 processed by the plasma process is 100%, the percentage improvement in adhesion property of the porous dielectric layer indicated by the bar graph 2 processed by the plasma process is 125%, the percentage improvement in adhesion property of the low dielectric constant layer indicated by bar 3 processed by the plasma process is 175%, and the percentage improvement in adhesion property of the low dielectric constant layer indicated by the bar graph 4 processed by the plasma process is 410%. Accordingly, it can be inferred from FIG. 3 that the plasma process of the present invention greatly improves the adhesion property of the dielectric layer.

In summary, the present invention has at least the following advantages.

First, the adhesion property of the dielectric layer is improved by the surface of the dielectric layer using a plasma gas containing helium or hydrogen, and therefore the problems such as peeling or delamination of any film/layer adhered to the dielectric layer may be effectively avoided, Thus, the yield rate and reliability of the semiconductor device can be effectively promoted.

Second, the plasma gas used for treating the surface of the dielectric layer and the conductive layer includes helium or hydrogen, and therefore defects on the surface of the dielectric layer or oxidation of the surface of the conductive layer due to exposure to Ar or NH3 may be effectively avoided.

Third, any residues of the slurry on the surface of the conductive layer after the CMP process may be removed by the plasma process so that defects in the subsequent fabrication processes may be effectively avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of improving adhesion property of a dielectric layer, comprising:
forming a dielectric layer over a substrate;
performing a plasma process to treat a surface of the dielectric layer, wherein the plasma process comprises a plasma gas containing helium or hydrogen, and
forming a cap layer over the dielectric layer.

2. The method of improving adhesion property of a dielectric layer as claimed in claim 1, wherein the material of the dielectric layer comprises a low dielectric constant material or a porous dielectric material.

3. The method of improving adhesion property of a dielectric layer as claimed in claim 1, wherein the dielectric constant of the dielectric layer is less than 3.5.

4. The method of improving adhesion property of a dielectric layer as claimed in claim 1, wherein the method of forming the dielectric layer comprises a plasma enhanced chemical vapor deposition method or spin on coating method.

5. The method of improving adhesion property of a dielectric layer as claimed in claim 1, wherein a flow rate of the plasma gas is in a range of 100 SCCM to 100,000 SCCM.

6. The method of improving adhesion property of a dielectric layer as claimed in claim 1, wherein a pressure of the plasma a process is in a range of 2.5 torr to 20 torr.

7. The method of improving adhesion property of a dielectric layer as claimed in claim 1, wherein a temperature of the plasma process is in a range of 200° C. to 450° C.

8. The method improving adhesion property of a dielectric layer as claimed in claim 1, wherein a plasma source of the plasma process comprises a single frequency radio frequency or a dual frequency radio frequency.

9. The method of improving adhesion property of a dielectric layer as claimed in claim 1, wherein a plasma power of the plasma surface process is in a range of 100 watt to 300 watt.

10. The method of improving adhesion property of a dielectric layer as claimed in claim 1, wherein the material of the cap layer comprises SiN, SiCN, SiCO or SiNO.

11. The method of improving adhesion property of a dielectric layer as claimed in claim 1, wherein the method of forming the cap layer comprises a chemical vapor deposition method.

12. The method of improving adhesion property of a dielectric layer as claimed in claim 1, wherein the plasma process is performed by the in-situ method.

13. The method of improving adhesion property of a dielectric layer as claimed in claim 1, wherein the plasma process is performed by the ex-situ method.

14. An interconnect process, comprising:
forming a dielectric layer over a substrate;
forming an opening in the dielectric layer;
forming a conductive layer over the dielectric layer, wherein the conductive layer fills the opening;
removing a portion of the conductive layer until a portion of the dielectric layer is exposed;
performing a plasma process to treat a surface of the dielectric layer, wherein the plasma process comprises a plasma gas containing helium or hydrogen; and
forming a cap layer over the dielectric layer and the conductive layer.

15. The interconnect process as claimed in claim 14, wherein the material of the dielectric layer comprises a low dielectric constant material or a porous dielectric material.

16. The interconnect process as claimed in claim 14, wherein the dielectric constant of the dielectric layer is less than 3.5.

17. The interconnect process as claimed in claim 14, wherein the method of forming the dielectric layer comprises a plasma enhanced chemical vapor deposition method or a spin on coating method.

18. The interconnect process as claimed in claim 14, wherein the method of forming the opening in the dielectric layer comprises:
forming a patterned photoresist layer over the dielectric layer; and
etching the dielectric layer using the patterned photoresist layer as the etching mask to remove a portion of the dielectric layer to form the opening.

19. The interconnect process as claimed in claim 14, wherein the material of the conductive layer comprises Cu, Al, W or alloy thereof.

20. The interconnect process as claimed in claim 14, wherein the method of removing a portion of the conductive layer to expose a portion of the dielectric layer comprises a chemical mechanical polishing method.

21. The interconnect process as claimed in claim 14, wherein a flow rate of the plasma gas is in a range of 100 SCCM to 100,000 SCCM.

22. The interconnect process as claimed in claim 14, wherein a pressure of the plasma process is in a range of 2.5 torr to 20 torr.

23. The interconnect process as claimed in claim 14, wherein a temperature of the plasma process is in a range of 200° C. to 450° C.

24. The interconnect process as claimed in claim 14, wherein a plasma source of the plasma process comprises a single frequency radio frequency or a dual frequency radio frequency.

25. The interconnect process as claimed in claim 14, wherein a plasma power of the plasma process is in a range of 100 watt to 300 watt.

26. The interconnect process as claimed in claim 14, wherein the material of the cap layer comprises SiN, SiCN, SiCO or SiNO.

27. The interconnect process as claimed in claim 14, wherein the method of forming the cap layer comprises a chemical vapor deposition method.

28. The interconnect process as claimed in claim 14, wherein the plasma process is performed by the in-situ method.

29. The interconnect process as claimed in claim 14, wherein the plasma process is performed by the ex-situ method.
